(19) United States
(12) Patent Application Publication
(10) Pub. No.: US 2014/0310753 A1
(43) Pub. Date: Oct. 16, 2014

(54) TV APPARATUS AND METHOD FOR RECORDING AND PLAYING MULTIMEDIA AUDIOVISUAL PROGRAM

(71) Applicant: HON HAI PRECISION INDUSTRY CO., LTD., New Taipei (TW)

(72) Inventors: CHENG-CHI WU, New Taipei (TW); KUO-CHIH YU, New Taipei (TW)

(73) Assignee: HON HAI PRECISION INDUSTRY CO., LTD., New Taipei (TW)

(21) Appl. No.: 14/252,737

(22) Filed: Apr. 14, 2014

(30) Foreign Application Priority Data
Apr. 16, 2013 (TW) 102113455

(51) Int. Cl. H04N 21/2747; H04N 21/41; H04N 21/2225

(52) U.S. Cl. CPC H04N 21/2747; H04N 21/2225; H04N 21/4122
USPC 725/74

(57) ABSTRACT

In a method for recording and playing multimedia audiovisual programs using a first television, the first television being is connected to a second television. The first television records a current multimedia audiovisual program being played on the first television in response to a recording command generated according to a user's operation, and sends the recorded multimedia audiovisual program to the second television according to an invoking command received from the second television.

### BACKGROUND

1. Technical Field

The present disclosure relates to television (TV) program management technology, especially to a television and method for recording and playing a multimedia audiovisual program.

2. Related Arts

When a user needs to record a desired television (TV) program, the user has to preset a recording command for controlling a TV before recording the desired TV program. If the user is not at home, the recording command cannot be preset for the TV, and the desired TV program is not recorded. In addition, even when the desired TV program is recorded successfully, the user has to watch the recorded TV program using the TV that recorded the program.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a first embodiment of a TV system in connection with a first TV and a second TV.

FIG. 2 is a block diagram of a second embodiment of a TV system in connection with a first TV and a second TV.

FIG. 3 is a flowchart of one embodiment of a method for recording and playing multimedia audiovisual programs.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

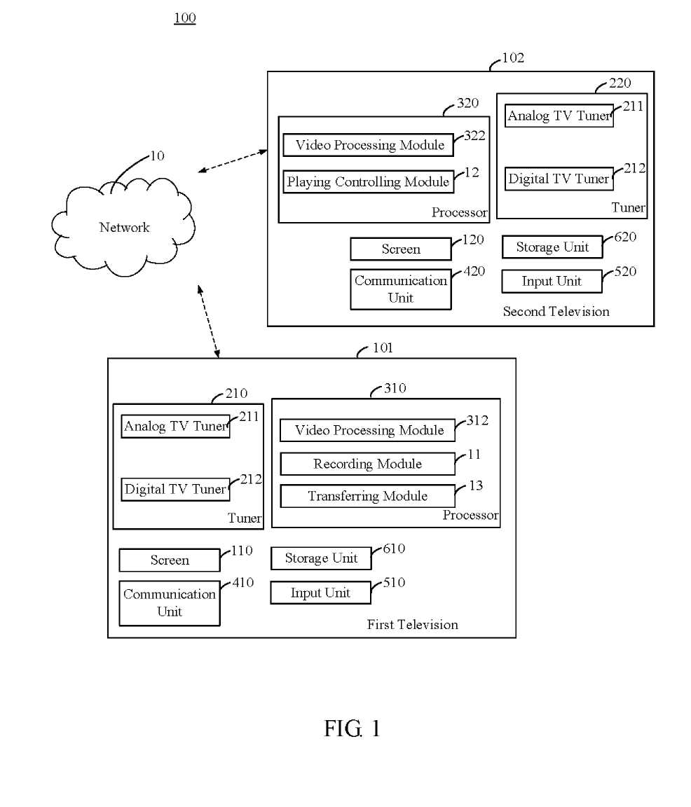

FIG. 1 illustrates a first embodiment of a TV system 100. The TV system 100 includes at least two televisions. In this embodiment, the TV system 100 includes two televisions. A first television 101 includes a screen 110, a tuner 210, a processor 310, a communication unit 410, an input unit 510, and a storage unit 610. A second television 102 is substantially similar to the first television 101. The second television 102 includes a screen 120, a tuner 220, a processor 320, a communication unit 420, an input unit 520, and a storage unit 620. The input units 510 and 520 can be hard buttons or touch buttons of the corresponding television or remote device, and also can be a voice controlling apparatus or three dimensional gesture controlling apparatus.

The tuner 210 of the first television 101 receives wired or wireless TV signals, and tunes and converts the TV signals into digital video transport-stream. In this embodiment, the tuner 210 includes an analog TV tuner 211 that receives analog TV signals, and a digital TV tuner 212 that receives digital TV signals. The tuner 210 further transfers the converted digital video transport-stream to the processor 310.

The processor 310 includes a video processing module 312 that processes the converted digital video transport-stream, transfers the video signals in the converted digital video transport-stream to the screen 110, and transfers the audio signals in the converted digital video transport-stream to a loudspeaker (not shown).

The communication unit 410 connects the first television 101 to a network 10. In this embodiment, the network 10 is the Internet. The communication unit 410 connects to an Ethernet interface unit through wires or wireless. In other embodiments, the network 10 is a communication network or a local area network based on BLUETOOTH, ZIGBEE, or WIFI, for example.

The second TV 102 is substantially similar to the first television 101. The processor 320 also includes a video processing module 322. The functions and working processes of the video processing module 322, the tuner 220, and the communication unit 410 are the same as the corresponding components in the first television 101.

The TV system 100 includes a recording module 11, a playing controlling module 12, and a transferring module 13. In one embodiment, the recording module 11 and the transferring module 13 can be executed by the processor 310 of the first television 101, and the playing controlling module 12 can be executed by the processor 320 of the second television 102.

The recording module 11 records a current multimedia audiovisual program being played on the first television 101 in response to a recording command. The recording module 11 stores the recorded multimedia audiovisual program in the storage unit 610 of the first television 101. In some embodiments, the input unit 510 generates the recording command corresponding to a selection operation or an inputting operation of a user. In detail, the tuner 210 converts the TV signals into digital video transport-stream, and the recording module 11 records the converted digital video transport-stream into the storage unit 610 with a predetermined video format. The predetermined video format can be Motion Picture Experts Group (MPEG), Audio Video Interleaved (AVI), FLASH VIDEO (FLV), Advanced Streaming format (ASF), or the like. In some embodiments, the recording module 11 can determine a recording length according to the recording command, and the recording length can be a predetermined time duration inputted by the user. In other embodiments, the recording module 11 can continue recording the current multimedia audiovisual program until the storage unit 610 is full when the recording command does not correspond to any recording length. The recorded multimedia audiovisual program also can be stored in a network storage space.

The transferring module 13 of the first television 101 transfers the recorded multimedia audiovisual program to the second television 102.

The playing controlling module 12 of the second television 102 generates an invoking command and controls the second television 102 to send the invoking command to the first television 101 in response to a playing command. The transferring module 13 of the first television 101 sends the recorded multimedia audiovisual program to the second television 102 via the communication unit 410 according to the received invoking command. Similarly, the playing command is generated by the input unit 520 of the second television 102 in response to a selection operation or an inputting operation of the user. The first television 101 receives the invoking command via the communication unit 410.

The second television 102 receives the multimedia audiovisual program sent by the first television 101 via the communication unit 420. The video processing module 322 processes the received multimedia audiovisual program to obtain video signals and audio signals, transfers the video signals to the screen 110, and transfers the audio signals to the loudspeaker.

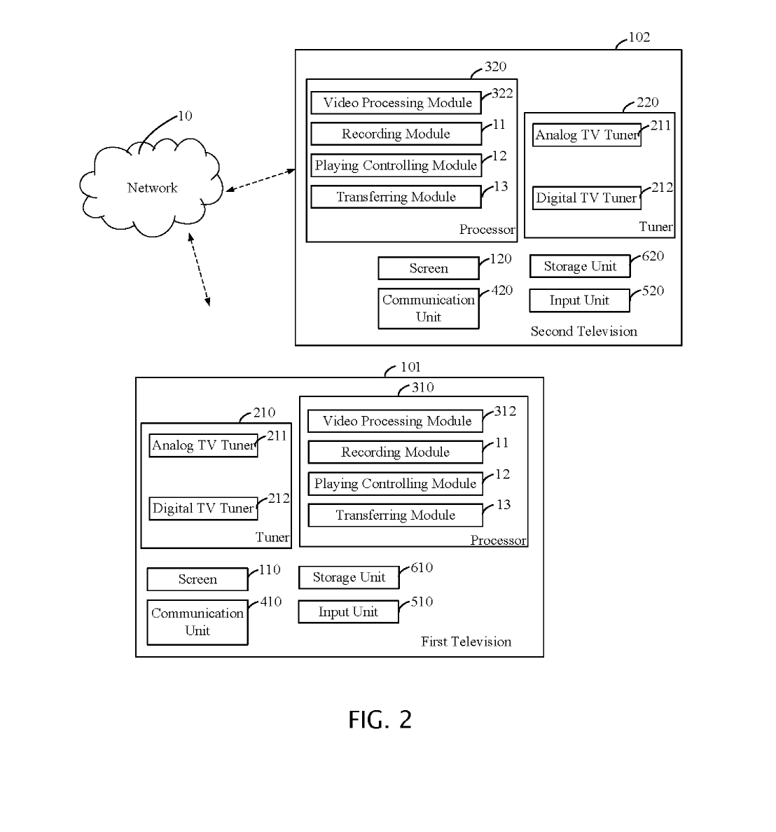

FIG. 2 illustrates a second embodiment of the TV system. The second television 102 includes the recording module 11 and the transferring module 13, and the first television 101 includes the playing controlling module 12. Depending on the second embodiment, both the first television 101 and the second television 102 can record specified multimedia audiovisual programs, and transmit the recorded specified multimedia audiovisual programs to each other.

By utilizing the TV system 100, the user can watch the recorded multimedia audiovisual program anywhere. For example, the user can control a TV at home to record a desired program, and then watch the recorded program on another TV at a hotel or an office.

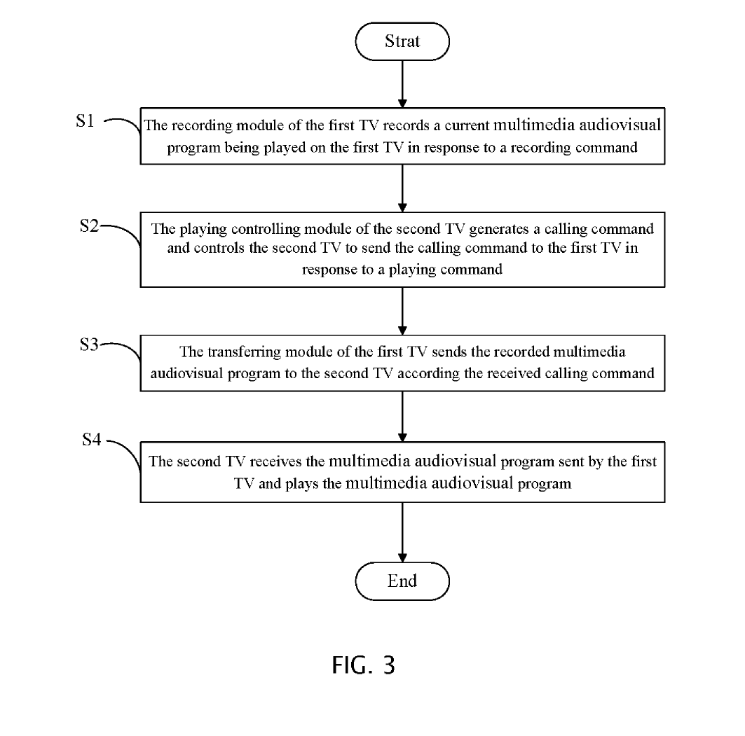

FIG. 3 illustrates a flowchart of an embodiment of a method for recording and playing multimedia audiovisual programs using the TV system 100. The method includes the following steps, each of which is tied to various components contained in the TV system 100 as shown in FIG. 1.

In step S1, the recording module 11 of the first television 101 records a current multimedia audiovisual program being played on the first television 101 in response to a recording command.

In step S2, the playing controlling module 12 of the second television 102 generates an invoking command and controls the second television 102 to send the invoking command to the first television 101 in response to a playing command.

In step S3, the transferring module 13 of the first television 101 sends the recorded multimedia audiovisual program to the second television 102 according the received invoking command.

In step S4, the second television 102 receives the multimedia audiovisual program sent by the first television 101 and plays the multimedia audiovisual program.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A method for recording and playing multimedia audiovisual program using a first television, the first television being connected to a second television, the method comprising:
recording a current multimedia audiovisual program being played on the first television in response to a recording command generated according to a user operation;
sending the recorded multimedia audiovisual program to the second television according to an invoking command received from the second television.

2. The method as described in claim 1, wherein the recorded multimedia audiovisual program is stored with a predetermined video format.

3. The method as described in claim 1, wherein the recorded multimedia audiovisual program is stored in a network storage space with a predetermined video format.

4. The method as described in claim 1, wherein the recorded multimedia audiovisual program is stored in a storage unit of the first television with a predetermined video format.

5. A method for recording and playing multimedia audiovisual program using a second television, the second television being connected to a first television, the method comprising:
generating an invoking command in response to a playing command generated according to a user operation;
sending the invoking command to the first television, which records a multimedia audiovisual program being played on the first television; and
in response to receiving the recorded multimedia audiovisual program from the first television, playing the multimedia audiovisual program on the second television.

6. A first television apparatus in connection to a second television, comprising:
a screen;
a tuner;
a processor; and
a plurality of storage devices storing a plurality of instructions, which when executed by the processor, causes the processor to:
generate an invoking command in response to a playing command generated according to a user operation;
send the invoking command to the second television, which records a multimedia audiovisual program being played on the second television; and
in response to receiving the recorded multimedia audiovisual program from the second television, playing the multimedia audiovisual program on the first television.

7. The first television apparatus as described in claim 6, wherein the processor further:
records a current multimedia audiovisual program being played on a first television in response to a recording command generated according to a user operation;
sends the recorded multimedia audiovisual program to the second television according to an invoking command received from the second television.

8. The first television apparatus as described in claim 7, wherein the recording module records the recorded multimedia audiovisual program via a predetermined video format.

9. The first television apparatus as described in claim 7, wherein the recording module records the recorded multimedia audiovisual program in a network storage space via a predetermined video format.

10. The first television apparatus as described in claim 7, wherein the recording module records the recorded multimedia audiovisual program in a storage unit of the first television via a predetermined video format.
